(19) United States
(12) Patent Application Publication
(10) Pub. No.: US 2024/0340053 A1
(43) Pub. Date: Oct. 10, 2024

(54) RELIABILITY ENHANCEMENTS FOR IMPLICIT BEAM SWITCH

(71) Applicant: QUALCOMM Incorporated, San Diego, CA (US)

(72) Inventors: Fang Yuan, Beijing (CN); Yan Zhou, San Diego, CA (US); Mostafa Khoshnevisan, San Diego, CA (US); Konstantinos Dimou, New York, NY (US); Sony Akkarakaran, Poway, CA (US); Tao Luo, San Diego, CA (US); Junyi Li, Fairless Hills, PA (US); Peter Gaal, San Diego, CA (US)

(21) Appl. No.: 18/580,497

(22) PCT Filed: Sep. 30, 2021
(86) PCT No.: PCT/CN2021/122219

§ 371 Date: Jan. 18, 2024

(51) Int. Cl. H04B 7/06; H04W 72/044

(52) U.S. Cl. CPC H04B 7/0626; H04B 7/06952; H04W 72/046

(57) ABSTRACT

This disclosure provides systems, methods, and devices for wireless communication that support reliability enhancements for implicit beam switching operations. In a first aspect, a method of wireless communication includes transmitting, by a wireless communication device, a channel state information (CSI) report using a first beam; monitoring, by the wireless communication device, for an implicit beam switch indication during a time window, the implicit beam switch indication corresponding to acceptance of Transmission Configuration Indicator (TCI) information indicated by the CSI report; and switching, by the wireless communication device, to a second beam from the first beam based on the implicit beam switch indication, the second beam different from the first beam. Other aspects and features are also claimed and described.

### TECHNICAL FIELD

Aspects of the present disclosure relate generally to wireless communication systems, and more particularly, to implicit beam switching operations. Some features may enable and provide improved communications, including reliability enhancements for implicit beam switching operations.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method for wireless communication includes transmitting, by a wireless communication device, a channel state information (CSI) report using a first beam; monitoring, by the wireless communication device, for an implicit beam switch indication during a time window, the implicit beam switch indication corresponding to acceptance of TCI information indicated by the CSI report; and switching, by the wireless communication device, to a second beam from the first beam based on the implicit beam switch indication, the second beam different from the first beam.

In an additional aspect of the disclosure, an apparatus includes at least one processor and a memory coupled to the at least one processor. The at least one processor is configured to transmit a channel state information (CSI) report using a first beam; monitor for an implicit beam switch indication during a time window, the implicit beam switch indication corresponding to acceptance of TCI information indicated by the CSI report; and switch to a second beam from the first beam based on the implicit beam switch indication, the second beam different from the first beam.

In an additional aspect of the disclosure, an apparatus includes means for transmitting a channel state information (CSI) report using a first beam; means for monitoring for an implicit beam switch indication during a time window, the implicit beam switch indication corresponding to acceptance of TCI information indicated by the CSI report; and means for switching to a second beam from the first beam based on the implicit beam switch indication, the second beam different from the first beam.

In an additional aspect of the disclosure, a non-transitory computer-readable medium stores instructions that, when executed by a processor, cause the processor to perform operations. The operations include transmitting, by a wireless communication device, a channel state information (CSI) report using a first beam; monitoring, by the wireless communication device, for an implicit beam switch indication during a time window, the implicit beam switch indication corresponding to acceptance of TCI information indicated by the CSI report; and switching, by the wireless communication device, to a second beam from the first beam based on the implicit beam switch indication, the second beam different from the first beam.

In another aspect of the disclosure, a method for wireless communication includes receiving, by a wireless communication device, a channel state information (CSI) report using a first beam; communicating, by the wireless communication device, an implicit beam switch indication during a time window, the implicit beam switch indication corresponding to acceptance of TCI information indicated by the CSI report; and switching, by the wireless communication device, to a second beam from the first beam based on the implicit beam switch indication, the second beam different from the first beam.

In an additional aspect of the disclosure, an apparatus includes at least one processor and a memory coupled to the at least one processor. The at least one processor is configured to receive a channel state information (CSI) report using a first beam; communicate an implicit beam switch indication during a time window, the implicit beam switch indication corresponding to acceptance of TCI information indicated by the CSI report; and switch to a second beam from the first beam based on the implicit beam switch indication, the second beam different from the first beam.

In an additional aspect of the disclosure, an apparatus includes means for receiving a channel state information (CSI) report using a first beam; means for communicating an implicit beam switch indication during a time window, the implicit beam switch indication corresponding to acceptance of TCI information indicated by the CSI report; and means for switching to a second beam from the first beam based on the implicit beam switch indication, the second beam different from the first beam.

In an additional aspect of the disclosure, a non-transitory computer-readable medium stores instructions that, when executed by a processor, cause the processor to perform operations. The operations include receiving, by a wireless communication device, a channel state information (CSI) report using a first beam; communicating, by the wireless communication device, an implicit beam switch indication during a time window, the implicit beam switch indication corresponding to acceptance of TCI information indicated by the CSI report; and switching, by the wireless communication device, to a second beam from the first beam based on the implicit beam switch indication, the second beam different from the first beam.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects.

FIG. 2 is a block diagram illustrating examples of a base station and a user equipment (UE) according to one or more aspects.

FIG. 3 is a diagram illustrating an example of implicit beam switch operations.

FIG. 4 is a block diagram illustrating an example wireless communication system that supports enhanced implicit beam switching operations according to one or more aspects.

FIG. 5 is a ladder diagram illustrating an example wireless communication system that supports enhanced implicit beam switching operations according to one or more aspects.

FIG. 6 is a ladder diagram illustrating another example wireless communication system that supports enhanced implicit beam switching operations according to one or more aspects.

FIG. 7 is a ladder diagram illustrating another example wireless communication system that supports enhanced implicit beam switching operations according to one or more aspects.

FIG. 8 is a ladder diagram illustrating another example wireless communication system that supports enhanced implicit beam switching operations according to one or more aspects.

FIG. 9 is a flow diagram illustrating an example process that supports enhanced implicit beam switching operations according to one or more aspects.

FIG. 10 is a flow diagram illustrating an example process that supports enhanced implicit beam switching operations according to one or more aspects.

FIG. 11 is a block diagram of an example UE that supports enhanced implicit beam switching operations according to one or more aspects.

FIG. 12 is a block diagram of an example base station that supports enhanced implicit beam switching operations according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology.

Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., −1 M nodes/km²), ultra-low complexity (e.g., −10 s of bits/sec), ultra-low energy (e.g., −10+ years of battery life), and deep coverage with the capability to reach challenging locations; (2) including mission-critical control with strong security to safeguard sensitive personal, financial, or classified information, ultra-high reliability (e.g., −99.9999% reliability), ultra-low latency (e.g., −1 millisecond (ms)), and users with wide ranges of mobility or lack thereof; and (3) with enhanced mobile broadband including extreme high capacity (e.g., −10 Tbps/km²), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FRI, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

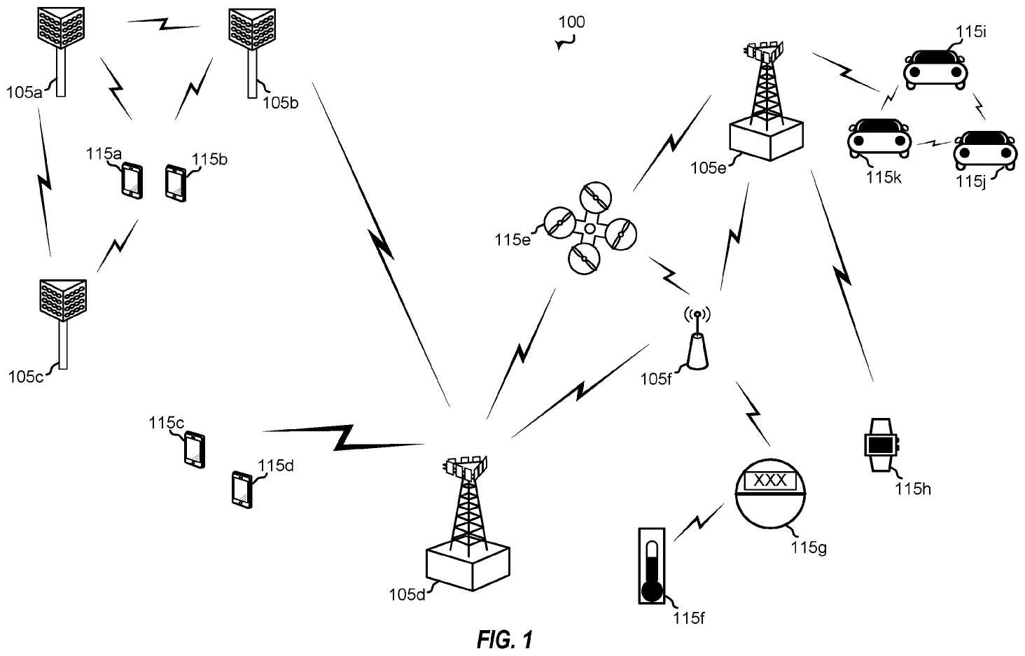

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-JoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105e.

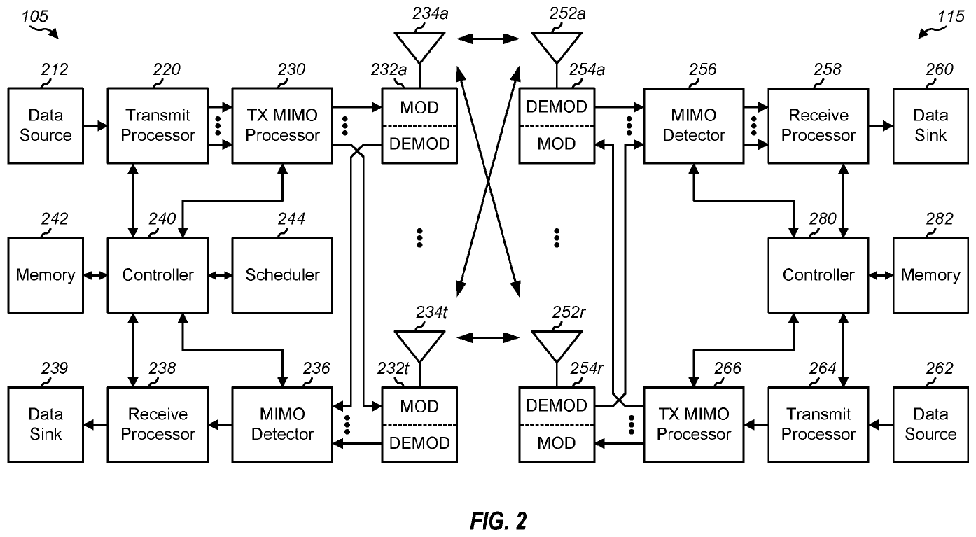

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

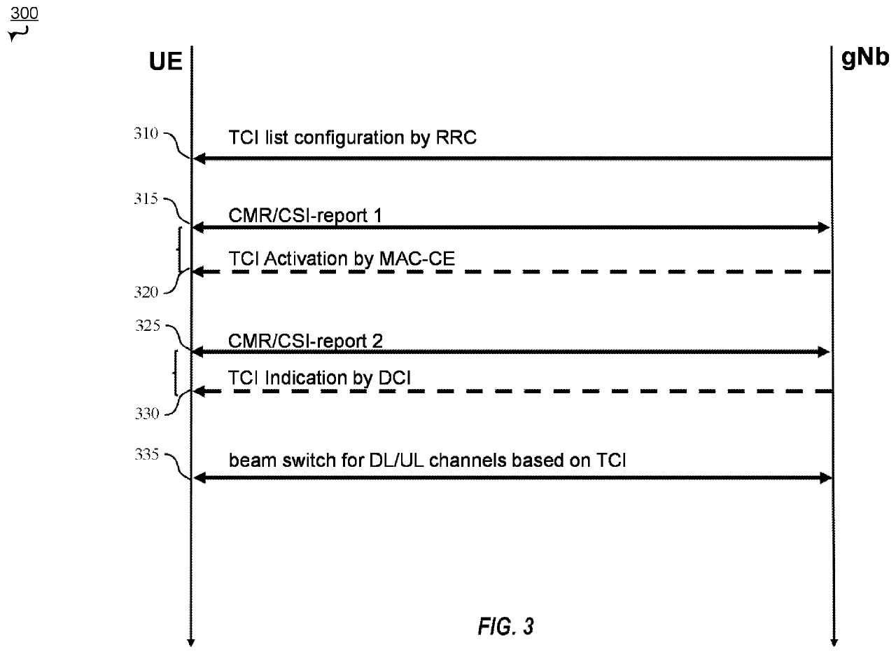

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the execution illustrated in FIGS. 3-10, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

FIG. 3 illustrates an example diagram of implicit beam switching operations. Specifically, FIG. 3 illustrates implicit beam indication and activation operations for implicit beam switching. As shown in FIG. 3, devices may reduce network overhead by refraining from transmitting certain transmissions used for conventional explicit beam switching operations. Specifically, in the example of FIG. 3, a TCJ activation message (e.g., TCI Activation MAC CE), a TCI indication message (e.g., TCI Indication DCI), or both, as used in conventional explicit beam switching operations, may not be used to perform implicit beam switching operations. The dashed lines indicate one or more messages which may be optional or eliminated.

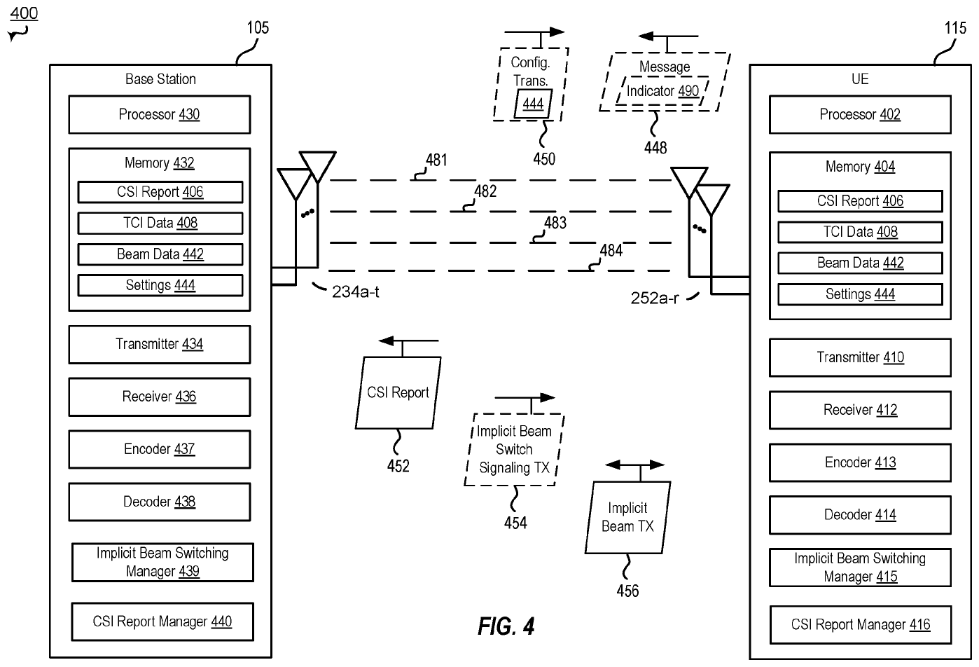

Such activation or configuration of implicit beam switching operations may be performed by separate signaling not shown in FIG. 3. Examples of such signaling are further described with reference to FIGS. 4-8, but may include higher layer messages, such as RRC message. The activation or configuration of implicit beam switching operations may indicate or activate a particular type of implicit beam switching operations, such as implicit beam indication, implicit beam activation, or both implicit beam indication and activation. Additionally or alternatively, the activation or configuration of implicit beam switching operations may include configuration of the signaling used for activation or configuration of implicit beam switching operations, an amount and type of time windows used for implicit beam switching reliability enhancements, or both. For example, the configuration may include indication of what type of messages can be used to coordinate if or when to use the implicitly indicated/determined beam. As another example, the configuration may indicate whether to use an activation time window, a confirmation time window, a rejection time window, a pre-cancellation time window, or a combination thereof.

In the example of FIG. 3, the network includes a network device, such as a base station 105, and a UE 115. At 310, the base station 105 transmits Transmission Configuration Indicator (TCI) configuration information in an RRC message. The TC list configuration information may include a list of TCIs (e.g., TCJ states) for use by the UE 115. The list of TCIs or TCJ states may be arranged into groups or subsets of TCIs or TCJ states. The TCI state may include downlink only TCI states (DL TCIs) which are applicable to downlink channels, uplink only TCI states (UL TCIs) which are applicable to uplink channels, or joint TCI states (Joint TCIs) which are applicable both downlink and uplink channels. A particular TCJ or TCI state may be associated with a corresponding beam or beams (e.g., such as for a particular type of message or communication direction) and may be used as an implicit indicator of a particular beams to use.

At 315, the UE 115 transmits a first CSI report to the base station 105. For example, the UE 115 performs measurements or evaluations, generates a first CSI report based on the measurements or evaluations, and transmits the first CSI report to the base station 105. The first CSI report may include or correspond to a first type of CSI report. The type of the first CSI report may also include or correspond to an implicit beam switching type CSI report. Additionally or alternatively, the first CSI report may be generated based on the configured channel management resources (CMRs).

Although not shown in FIG. 3, there may be additional configuration and/or trigger signaling to enable transmission of the first CSI report. For example, the first CSI report may be periodically or aperiodically transmitted. If aperiodic, a trigger message, such as a DCI with CSI request, may be sent by the base station 105 prior to the first CSI report to trigger the report. Additionally, or alternatively, one or more RRC message may be sent by the base station 105 prior to the first CSI report to configure a timing or layout of the first CSI report, such as the periodicity and the time offset for CSI reporting.

At 320, the base station 105 may optionally transmit a TCI activation information message to the UE 115. For example, the base station 105 transmits a TCI activation MAC CE to the UE 115 including TCI activation information. The TCI activation information indicates which TCIs or TCI states (e.g., group or subsets) of the configured list of TCIs to activate for possible future use. The base station 105 may determine which TCIs or TCI states (e.g., group or subsets) of the configured list of TCIs or TCI states to activate based on the first CSI report.

The TCI activation information message may be sent for explicit beam switching operations and for some implicit beam switching operations where a TCI indication message is not used. In such cases, the base station 105 transmits a TCI activation information/message to the UE 115.

Alternatively, in other implicit beam switching operations (e.g., in implicit activation operations), the base station 105 does not transmit, e.g., refrains from transmitting the TCI activation information. Instead, the UE 115 and the base station 105 both independently determine which TCIs to activate based on the first CSI report. For example, the CSI report may implicitly indicate which TCIs to activate. To illustrate, the UE 115 and base station 105 may both determine which TCIs to activate based on the first CSI report and one or more conditions. The devices may evaluate the first CSI report, such as the CMR thereof (confirm), based on the conditions (e.g., thresholds) to determine which of the configured TCIs to activate. Alternatively, the first CSI report may explicitly indicate which TCIs to activate.

At 325, the UE 115 transmits a second CSI report to the base station 105. For example, the UE 115 performs measurements or evaluations, generates a second CSI report based on the measurements or evaluations, and transmits the second CSI report to the base station 105. The second CSI report may include or correspond to a second type of CSI report different from the first type. The type of the second CSI report may also include or correspond to an implicit beam switching type CSI report. Additionally or alternatively, the second CSI report may be generated based on the configured channel management resources (CMRs).

Although not shown in FIG. 3, there may be additional configuration and/or trigger signaling to enable transmission of the second CSI report, as described for the first CSI report.

At 330, the base station 105 may optionally transmit a TCI indication information message to the UE 115. For example, the base station 105 transmits a TCI indication DCI to the UE 115 including TCI indication information. The TCI indication information indicates which TCI or TCI state of the activated TCIs or TCI states (e.g., group or subsets) to use for implicit beam switching. The base station 105 may determine which TCI or TCI state, and corresponding beam, of the activated TCIs or TCI states (e.g., group or subsets) to use for implicit beam switching based on the second CSI report.

The TCI indication information message may be sent for explicit beam switching operations and for some implicit beam switching operations where a TCI activation message is not used. In such cases, the base station 105 transmits a TCI indication information/message to the UE 115.

Alternatively, in other implicit beam switching operations (e.g., in implicit indication operations), the base station 105 does not transmit, e.g., refrains from transmitting the TCI indication information. Instead, the UE 115 and the base station 105 both independently determine which TCI or TCI state and beam to use based on the second CSI report. For example, the second CSI report may implicitly indicate which TCI or TI state to use. To illustrate, the UE 115 and base station 105 may both determine which TCI or TCI state to use based on the second CSI report and one or more conditions. The devices may evaluate the second CSI report, such as the CMR thereof (confirm), based on the conditions (e.g., thresholds) to determine which of the activated TCIs or TCI states to use. Alternatively, the second CSI report may explicitly indicate which TCI or TCI state to use.

After determining or receiving the TCI or TCI state to use based on the second CSI report, the device may determine which beam to use based on the TCI or TCI state. For example, the TCI or TCI state may be associated with or correspond to a particular beam for a particular type of transmission (e.g., CSI, SSB, PUSCH, etc.) or particular transmission direction (e.g., uplink or downlink). This association or correlation may be stored or indicated by an index, table, or formula and the device may determine the beam based on the index, table, or formula. In some implementations, the devices may determine to only use such implicitly determined beams for certain types of operations, such as for downlink only, uplink only, sidelink only, or a combination thereof.

The devices perform the implicit beam switch, and at 330, the devices begin to communicate using the beam or beams which were implicitly indicated. For example, as illustrated in FIG. 3, the devices transmit and receive messages in UL and DL using the beam determined based on the TCJ state in the second CSI report.

Implicit beam operations may offer improvements over conventional methods by reducing network overhead (e.g., beam switching signaling overhead) and messages and enabling beam faster switches. Reducing network overhead and using better performing beams earlier improves throughput and reliability for wireless communications.

In the aspects described herein, additional signaling and time windows may be used in conjunction with implicit beam switching to provide reliability enhancements and greater flexibility and control for implicit beam switching operations. Examples of such reliability enhancements include utilizing one or more time windows and signaling messages to provide an indication regarding implicit beam switching. This indication may include cancellation (e.g., pre-cancellation) of the implicit beam switching, activation of the implicit beam switching, confirmation of the implicit beam switching, or rejection of the implicit beam switching. Each time window may have its own associated signaling message, and multiple different time window types can be used in conjunction with each other to give greater flexibility and control. The time windows can be separate (e.g., be arranged serially) or can at least partially overlap with one another.

In some aspects, after transmitting a CSI report configured for implicit beam switch (e.g., either for TCJ indication or for TCI activation), the UE 115 may apply the implicit beam switch if the UE 115 receives a confirmation indication from the base station in a time window after the end of the transmission of the CSI report. In a first example, the confirmation indication may be a TCJ indication signaling (TCI indication DCI or a TCI activation MAC-CE) which indicates the same TCI as the one selected by the UE 115 from the CSI report for implicit beam switch. In a second example, the confirmation indication may be either a TCI indication signaling (TCI indication DCI or a TCI activation MAC-CE) which indicates the same TCI as the one selected by the UE 115 from the CSI report for implicit beam switch, or none of TCJ indication signaling for indicating a TCJ received at the UE 115 in the time window. In a third example, the confirmation indication may be not receiving a TCJ indication signaling (TCI indication DCI or a TCJ activation MAC-CE) for indicating a TCI at the UE 115 in the time window.

In a fourth example, the confirmation indication may be a dedicated confirmation signaling (DCI or MAC-CE) for confirming the implicit beam switch. If the UE 115 does not receive a confirmation signaling within a time window, the UE 115 may not apply the implicit beam switch. In some aspects, the time window may start from a first time offset from the end of the transmission of the CSI report. In some other aspects, the time window may end at a second time offset from the end of the transmission of the CSI report.

In some aspects, a TCI application time may be defined for implicit beam switch, and the TCI selected from the CSI report for implicit beam switch is applied when the TCI application time starts. In some aspects, for a base station scheduled downlink beam report (or uplink beam report), the joint TCI state or DL TCI state (or UL TCI state) corresponding to the best reported DL beam (or UL beam) is selected and applied for the applicable channels/RSs at the UE 115 if none of TCJ indication signaling (i.e., DCI or MAC-CE) reselecting the TCI state for the same applicable channels/RSs is received before the TCI application time starts. In some other aspects, the UE 115 may apply the implicit beam switch if no TCI indication signalling (i.e., DCI or MAC-CE) overwriting the selected TCI is received in a time window after the end of the report and before the TCI application time starts. If the TCI state selected by the UE 115 from the CSI report for implicit beam switch has been activated before the CSI report, the TCI application time starts in the first slot after X symbols from the end of the CSI report. If the TCI state selected by the UE 115 from the CSI report for implicit beam switch has not been activated before the CSI report, the TCI state application time starts in the first slot after Y milliseconds from the end of the CSI report. The value of X and Y may be determined based a rule according to a higher layer configuration (e.g., RRC message), a fixed value, or a UE capability. For example, Y may be a default fixed value of 3 milliseconds.

Reliability enhancements for implicit beam operations may offer improvements of reduced beam confusion, increased control, flexibility in the beam switching timing, etc.

Such reliability enhancements may reduce the chance and consequences of beam switching miscommunications and mismatch.

FIG. 4 illustrates an example of a wireless communications system 400 that supports enhanced implicit beam switching operations in accordance with aspects of the present disclosure. In some examples, wireless communications system 400 may implement aspects of wireless communication system 100. For example, wireless communications system 400 may include multiple wireless communication devices and optionally a network entity. In the example of FIG. 4, the wireless communications system 400 includes a base station 105, and a UE 115. Use of reliability enhancements for implicit beam switching operations may improve implicit beam switching operations. Improved implicit beam switching operations may reduce latency and increase throughput by decreasing failed transmissions, such as through decreased beam switching failures. Thus, network and device performance can be increased.

UE 115 and base station 105 may be configured to communicate via frequency bands, such as FR1 having a frequency of 410 to 7125 MHz, FR2 having a frequency of 24250 to 52600 MHz for mm-Wave, and/or one or more other frequency bands. It is noted that Sub-carrier spacing (SCS) may be equal to 15, 30, 60, or 120 kHz for some data channels.

UE 115 and base station 105 may be configured to communicate via one or more component carriers (CCs), such as representative first CC 481, second CC 482, third CC 483, and fourth CC 484. Although four CCs are shown, this is for illustration only, more or fewer than four CCs may be used. One or more CCs may be used to communicate control channel transmissions, data channel transmissions, and/or sidelink channel transmissions.

Such transmissions may include a Physical Downlink Control Channel (PDCCH), a Physical Downlink Shared Channel (PDSCH), a Physical Uplink Control Channel (PUCCH), a Physical Uplink Shared Channel (PUSCH), a Physical Sidelink Control Channel (PSCCH), a Physical Sidelink Shared Channel (PSSCH), or a Physical Sidelink Feedback Channel (PSFCH). Such transmissions may be scheduled by aperiodic grants and/or periodic grants.

Each periodic grant may have a corresponding configuration, such as configuration parameters/settings. The periodic grant configuration may include configured grant (CG) configurations and settings. Additionally, or alternatively, one or more periodic grants (e.g., CGs thereof) may have or be assigned to a CC ID, such as intended CC ID.

Each CC may have a corresponding configuration, such as configuration parameters/settings. The configuration may include bandwidth, bandwidth part, HARQ process, TCI state, RS, control channel resources, data channel resources, or a combination thereof. Additionally, or alternatively, one or more CCs may have or be assigned to a Cell ID, a Bandwidth Part (BWP) ID, or both. The Cell ID may include a unique cell ID for the CC, a virtual Cell ID, or a particular Cell ID of a particular CC of the plurality of CCs. Additionally, or alternatively, one or more CCs may have or be assigned to a HARQ ID. Each CC may also have corresponding management functionalities, such as, beam management, BWP switching functionality, or both. In some implementations, two or more CCs are quasi co-located, such that the CCs have the same beam and/or same symbol.

In some implementations, control information may be communicated via UE 115 and base station 105. For example, the control information may be communicated using Medium Access Control (MAC) Control Element (MAC CE) transmissions, Radio Resource Control (RRC) transmissions, sidelink control information (SCI) transmissions, another transmission, or a combination thereof.

UE 115 can include a variety of components (e.g., structural, hardware components) used for carrying out one or more functions described herein. For example, these components can includes processor 402, memory 404, transmitter 410, receiver 412, encoder, 413, decoder 414, implicit beam switching manager 415, CSI report manager 416, and antennas 252a-r. Processor 402 may be configured to execute instructions stored at memory 404 to perform the operations described herein. In some implementations, processor 402 includes or corresponds to controller/processor 280, and memory 404 includes or corresponds to memory 282. Memory 404 may also be configured to store report data 406, TCI data 408, beam information data 442, settings data 444, or a combination thereof, as further described herein.

The CSI report data 406 includes or corresponds to data associated with or corresponding to data for CSI reporting. The CSI report data 406 may indicate or enable determination of TCI states and implicit indication of beams for various communications. The CSI report data 406 may include or correspond to a CSI report or data for generating a CSI report. Such may include CSI report settings, such as timing and type.

The TCI data 408 includes or corresponds to data associated or corresponding to TCI state information. The TCI data 408 may indicate a particular TCJ state and a corresponding beam. For example, the TCI data 408 may include a particular selected or in use TCI state and information (e.g., an index, table, or formula) associating the TCJ state with a corresponding beam. The TCJ data 408 may optionally include data for TCJ indication and activation operations. For example, the TC data 408 may include a list of configured TCJ states, a selected subset or group of activated TCJ states from the configured list of TCJ states, a particular selected TCI state, or a combination thereof. Additionally, or alternatively, the TCI data 408 may include data for performing implicit TCJ indication and/or activation operations, such as the operations described with reference to FIG. 3.

The beam information data 442 includes or corresponds to data associated with transmission and/or reception beams. The beam information data 442 may include preset beam (e.g., SSB #1) information or formulas or equations for determining beam parameters (e.g., beamforming weights) for beams. Additionally, or alternatively, the beam information data 442 may include association information (e.g., an index, table, or formula) for associating one or more of the beams with one or more corresponding TCI states.

The settings data 444 includes or corresponds to data associated with implicit beam switching operations. The settings data 444 may include settings and/or conditions data for determination, indication/signaling, or reporting procedures for implicit beam switching operations. The settings data 444 may include condition information (e.g., thresholds), type operations (e.g., implicit indication, implicit activation, or both), communication type settings (e.g., uplink, downlink, sidelink, etc.), time window information (e.g., amount, type, timing, etc.), or a combination thereof.

Transmitter 410 is configured to transmit data to one or more other devices, and receiver 412 is configured to receive data from one or more other devices. For example, transmitter 410 may transmit data, and receiver 412 may receive data, via a network, such as a wired network, a wireless network, or a combination thereof. For example, UE 115 may be configured to transmit and/or receive data via a direct device-to-device connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate. In some implementations, transmitter 410 and receiver 412 may be replaced with a transceiver. Additionally, or alternatively, transmitter 410, receiver, 412, or both may include or correspond to one or more components of UE 115 described with reference to FIG. 2.

Encoder 413 and decoder 414 may be configured to encode and decode data for transmission. Implicit beam switching manager 415 may be configured to determine and perform implicit beam switching operations, including implicit beam activation, implicit beam indication, or a combination thereof. For example, the implicit beam switching manager 415 is configured to implicit beam activation operations based on CSI reporting. As another example, the implicit beam switching manager 415 is configured to implicit beam indication operations based on CSI reporting.

As an illustrative example of identification operations, the implicit beam switching manager 415 may determine which types of implicit switching operation or operations to perform. To illustrate, the implicit beam switching manager 415 may determine to perform implicit indication and/or activation and which time windows and signaling to sue. As an illustrative example of determination operations, the implicit beam switching manager 415 may evaluate received signaling and determine implicit beam switching procedures. As another illustrative example of determination operations, the implicit beam switching manager 415 may determine a beam for implicit switching based on a CSI report and TCI state information. As an illustrative example of reporting operations, the implicit beam switching manager 415 may determine to perform CSI reporting for implicit beam switching based on configuration information and/or signaling.

CSI report manager 416 may be configured to perform CSI reporting operations. For example, the CSI report manager 416 is configured to perform CSI evaluation operations, CSI report generation operations, and CSI report transmission operations. To illustrate, the CSI report manager 416 may determine CSI evaluation/measurement procedures for CSI reporting for implicit beam switching. As another illustration, the CSI report manager 416 may determine CSI reporting procedures (e.g., timing and layout/structure) for CSI reporting for implicit beam switching. As another example, the CSI report manager 416 may generate and transmit a CSI report for implicit beam switching (e.g., which implicitly indicates a beam).

Base station 105 includes processor 430, memory 432, transmitter 434, receiver 436, encoder 437, decoder 438, implicit beam switching manager 439, RRC state manager 440, and antennas 234a-t. Processor 430 may be configured to execute instructions stores at memory 432 to perform the operations described herein. In some implementations, processor 430 includes or corresponds to controller/processor 240, and memory 432 includes or corresponds to memory 242. Memory 432 may be configured to store CSI report data 406, TCI data 408, beam information data 442, settings data 444, or a combination thereof, similar to the UE 115 and as further described herein.

Transmitter 434 is configured to transmit data to one or more other devices, and receiver 436 is configured to receive data from one or more other devices. For example, transmitter 434 may transmit data, and receiver 436 may receive data, via a network, such as a wired network, a wireless network, or a combination thereof. For example, base station 105 may be configured to transmit and/or receive data via a direct device-to-device connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate. In some implementations, transmitter 434 and receiver 436 may be replaced with a transceiver. Additionally, or alternatively, transmitter 434, receiver, 436, or both may include or correspond to one or more components of base station 105 described with reference to FIG. 2.

Encoder 437, and decoder 438 may include the same functionality as described with reference to encoder 413 and decoder 414, respectively. Implicit beam switching manager 439 may include similar functionality as described with reference to implicit beam switching manager 415. CSI report manager 440 may include similar functionality as described with reference to CSI report manager 416.

During operation of wireless communications system 400, base station 105 may determine that UE 115 has implicit beam switching capability or enhanced implicit beam switching capability. For example, base station 105 or UE 115 may transmit a message 448 that includes an implicit beam switching capability indicator 490. Indicator 490 may indicate implicit beam switching capability or a particular type or mode of implicit beam switching operations. In some implementations, a base station 105 sends control information to indicate to UE 115 that enhanced implicit beam switching operations and/or a particular type of enhanced implicit beam switching capability operations are to be used. For example, in some implementations, message 448 (or another message, such as configuration transmission 450) is transmitted by the base station 105. The configuration transmission 450 may include or indicate to use enhanced implicit beam switching operations or to adjust or implement a setting of a particular type of enhanced implicit beam switching operations. For example, the configuration transmission 450 may include settings data 444, as indicated in the example of FIG. 4, in addition to or in the alternative of the list of configured TCIs or TCI states (e.g., TCI data 408).

During operation, devices of wireless communications system 400, perform enhanced implicit beam switching operations. For example, the base station 105 and the UE 115 perform implicit beam switching operations with reliability indications. To illustrate, the network (e.g., base station 105) may be able to control a proposed implicit beam switch during the implicit beam switch and provide an indication to the UE 115, such as to confirm, accept, rejection, or cancel the implicit beam switch.

In the example of FIG. 4, the UE 115 generates and transmits a CSI report transmission 452. The CSI report transmission 452 includes a CSI report, and the CSI report may include or correspond to the first or second CSI report of FIG. 3. That is, the CSI report transmission may implicitly activate a set of TCIs or indicate a particular TCI. By implicitly activating and/or indicating TCIs, the UE 115 may implicitly indicate a beam for switching. The UE 115 generates the CSI report transmission 452 which includes or indicates the CSI report data 406. The CSI report data 406 may include or indicate TCI data 408. The TCJ data 408 may implicitly indicate a beam. For example, the TCI data 408 and the beam information data 442 may be associated with one another such that a particular TCJ state corresponds with one or more beams.

The base station 105 receives the CSI report transmission 452 from the UE 115 and determines a TCI state or list of TCJ states (e.g., TCI data 408) from the CSI report (e.g., CSI report data 406). For implicit activation, when a list of TCI states is indicated the base station 105 determines to activate a group or subset of the configured TCI states. The base station 105 may then activate the group of TC states implicitly, as a first implicit portion of an implicit beam switch operation. The base station 105 may then perform implicit or explicit TCI/beam indication operations to complete the implicit beam switch operation.

For implicit indication, when a TCI state is indicated the base station 105 determines to a beam associated with the TCI state for implicit use by the UE 115. The base station 105 may then perform implicit beam switching to complete the implicit beam switch operation.

In the aspects described herein, the devices may perform reliability enhancements for implicit beam switching operations. For example, a receiving device (e.g., the network or another UE) may determine whether to perform the implicit beam switch and may optionally provide an indication regarding the devices determination on whether or not the implicit beam switch should be performed. For example, after the base station 105 receives the CSI report and determines the implicit indication of the CSI report, the base station 105 may determine whether to perform the implicit beam switch.

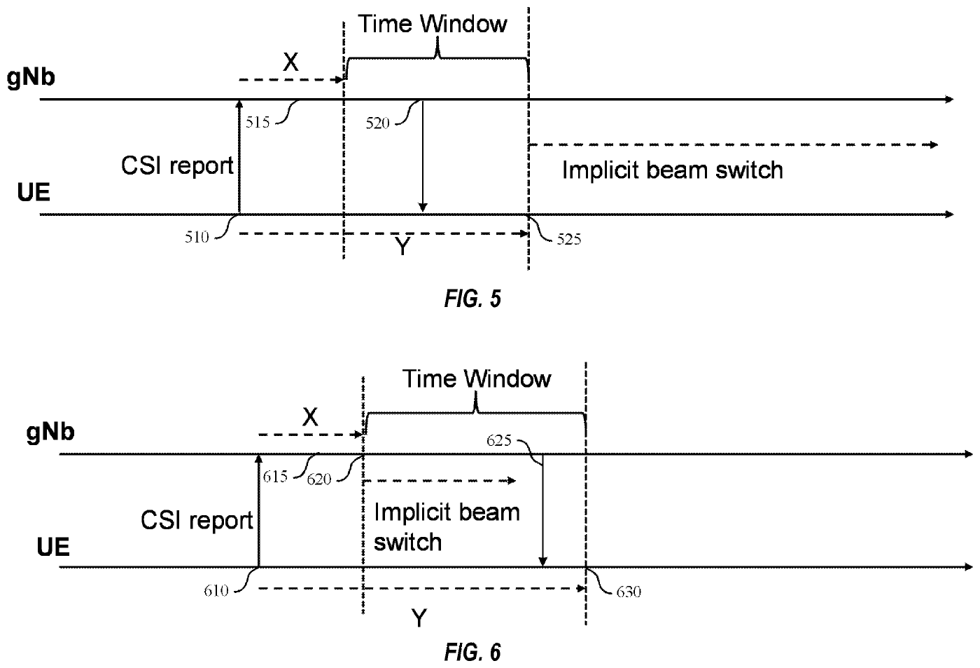

The network (e.g., the base station 105) may determine to provide an indication regarding the implicit beam switching information provided by the UE 115. For example, the network may attempt to activate/initiate the implicit beam switch or confirm the implicit beam switch or an aspect of the implicit beam switch. Alternatively, the network may attempt to cancel or reject the implicit beam switch. To provide such indication, the network may provide a positive indication, such as by sending a transmission, or by a negative indication, e.g., not sending a transmission. As illustrated in the example of FIG. 4, the base station 105 generates and transmits an implicit beam switch signaling transmission 454. To illustrate, the base station 105 may determine to accept or reject the implicit beam switch, and based on such determination, the base station 105 may determine to provide an indication of its determination, such as to accept, confirm, reject, cancel, etc. The base station 105 may generate and transmit the implicit beam switch signaling transmission 454 which includes a bit to provide a positive or negative indication regarding the implicit beam switch. Additionally, or alternatively, the base station 105 may generate and transmit the implicit beam switch signaling transmission 454 during a particular time window, such as any of the time windows described further with reference to FIGS. 5-8, to provide the indication. A transmission sent (or not sent) during a particular time window may act as an indication for implicit beam switching.

The indication may depend on the particular type of time window in which the transmission is sent. For example, when the implicit beam switch signaling transmission 454 is sent during a time window, the implicit beam switch signaling transmission 454 may indicate to activate the group of TCI states indicated in the CSI report or the TCI state/beam indicated in the CSI report. Additionally or alternatively, the indication could be provided by a particular type of transmission sent, such as DCI for a positive indication and a MAC CE for a negative indication.

The implicit beam switch signaling transmission 454 may include or correspond to a DCI or MAC CE, as described further with reference to FIGS. 5-8. When DCI signaling is used, the base station 105 may use a TCI indicator of an existing DCI or use a dedicated DCI. When MAC CE signaling is used, the base station 105 may use a TCI indicator of an existing MAC CE or use a dedicated MAC CE. In some implementations, different types of transmissions/signaling could be used for different procedures of the implicit beam switch operation. For example, one type of transmission could be used for implicit activation and another could be used for implicit indication.

The UE 115 (e.g., the implicit beam switch manager 415) may receive the implicit beam switch signaling transmission 454 and determine the indication thereof. The UE 115 may continue on with the implicit beam switch operation or may cancel or stop the implicit beam switch operation based on determining the indication. Examples of different operations for providing the indication are described further with reference to FIGS. 5-8. Although an optional message is indicated in the example of FIG. 4, in some implementations the indication is provided by not sending a message.

After receiving the indication, the UE 115 and base station 105 may perform one or more actions in accordance with the indication. For example, both devices may stop or cancel the beam switch operation. As another example, both devices may determine to perform an implicit beam switch operation or confirm the continued use of the implicitly indicated beam. In such implementations where an implicit beam switch is performed, the UE 115 and base station 105 may wirelessly communicate with the implicitly indicated beam. That is, the UE 115 and base station 105 may transmit and/or receives messages with the beam or beams implicitly activated or indicated by the CSI report. For example, the UE 115 may generate and transmit a transmission with the implicitly indicated beam, implicit beam transmission 456. The implicit beam transmission 456 may include or correspond to a PUCCH transmission or a PUSCH transmission in the example of FIG. 4. In other implementations, the transmission may be a downlink transmission, a sidelink transmission or another type of transmission (e.g., broadcast, groupcast, D2D, etc.).

The base station 105 receives the implicit beam transmission 456 using the implicitly indicated beam (or its corresponding receive beam), and may optionally transmit a message using an implicit indicated beam. As the devices were able to perform implicit beam switching, the devices can update their beams with less overhead. This enables more beam updates and better beam performance. Additionally, in the aspects described herein, the additional implicit beam switching indication (e.g., signaling) enables the network to have more control over the implicit beam switching and offers more flexibility in implicit beam switching operations. The implicit beam switching indication adds increased reliability over conventional or pure implicit beam switching operations.

Accordingly, the UE 115 and the base station 105 may be able to more effectively perform implicit beam switching operations. Thus, FIG. 4 describes enhanced implicit beam switching operations for wireless communication devices. Performing enhanced implicit beam switching operations enables improved reliability for implicit beam switching operations (e.g., improved cell selection and reselection) and thus, enhanced UE and network performance by increasing throughput and reducing errors and latency.

FIGS. 5-10 illustrate examples of ladder diagrams for reliability enhancements for implicit beam switching operations according to some aspects. The examples of FIGS. 5-10 include similar devices to the devices described in FIGS. 1, 2, and 4, such as UE 115 and base station 105. The devices, such as UE 115 and base station 105, of FIGS. 5-10 may include one or more of the components as described in FIGS. 2 and 4. In such FIGS. 5-10, these devices may utilize antennas 252a-r, transmitter 410, receiver 412, encoder 413 and/or decoder 414, or may utilize antennas 234a-t, transmitter 434, receiver 436, encoder 437 and/or decoder 438 to communicate transmissions and receptions.

Referring to FIG. 5, FIG. 5 is a ladder diagram 500 of a time window reliability enhancement for implicit beam switching operations according to some aspects. In the example of FIG. 5, the ladder diagram illustrates a UE 115 and a network entity, such as base station 105, utilizing an activation type time window or activation time window. In other examples and aspects, the implicit beam switching operations may occur between two wireless communication devices, such as two UEs.

In some implementations, the base station 105 optionally transmits a RRC Configuration transmission (not shown). The RRC configuration transmission may configure one or more parameters of the implicit beam switching operations, such as including one or more parameters of the reliability enhancements.

At 510, the UE 115 generates and transmits a CSI report to the network device. For example, the UE 115 generates a CSI report and transmits the CSI report to the base station 105 (such as a gNB). The CSI report may include one or more resource indexes (e.g., SSB resource indexes or CSI RS resource indexes) where each resource index may be associated with TCI state information (e.g., with aparticular TC state). The associated TCI state information in the CSI report may implicitly indicate or correspond to a particular beam. In some aspects, the CSIreport may be configured by the network device. In one example, the CSI report may be configured to report resource indexes associated with only DL TCIs. In another example, the CSI report may be configured to report resource indexes associated with only UL TCJs. In another example, the CSI report may be configured to report resource indexes associated with joint TCJs. In some aspects, the CSI report may be configured to report resource indexes associated with activated TCIs. In some other aspects, the CSI report may be configured to report resource indexes associated with non-activated TCIs. In some other aspects, the CSI report may be configured to report resource indexes associated with either activated or non-activated TCIs.

The UE 115 and base station 105 determine the beam for implicit switching based on the CSI report. For example, the implicit beam switching manager 415 of the UE 115 determines the beam based on the TCI state information of the CSI report. To illustrate, the UE 115 determines a TCI state based on the TCI state information of the CSI report, and then determines a corresponding beam based on the determined TCI state. For example, the UE 115 may select the joint TCI or DL-only TCI (or UL-only TCI) associated with or corresponding to the best reported resource index representing a DL beam (or UL beam) from the CSI report for later applying during an implicit beam switch operation. The implicit beam switch operation may include applying the selected TCI to the applicable channels or reference signals (RSs) if the selected TCI has been activated, or may include activating the selected TCI if the TCI has not been activated.

At 515, the base station 105 receives the CSI report and determines the beam that the UE 115 will switch to a particular beam. For example, the implicit beam switching manager 439 of the base station 105 receives the CSI report and determines the TCI state indicated by the CSI report. The base station 105 may then determine a particular beam based on, and which corresponds to, the TCI state for one or more wireless communications. The beam switch is an implicit one and it occurs independent of a TCI activation message.

The UE 115 and base station 105 determine a time window for implicit beam switching. The UE 115 and base station 105 may determine the time window from the CSI report and based on a previous configuration transmission or stored/preconfigured settings. For example, a timing of the time window may be determined by a time offsets from the transmission of the CSI report. For another example, a timing of the time window may be determined by the end of the transmission of the CSI report.

At 520, the base station 105 optionally transmits an TCI indication message during the time window. For example, the implicit beam switching manager 439 of the base station 105 determines whether or not to implement or activate the implicit beam switch and whether or not to use the implicitly determined beam by the UE 115. In response to determining to implement or activate the implicit beam switch and use of the implicitly determined beam by the UE, the base station 105 generates and transmits the TCI indication message during the time window as illustrated in FIG. 5. The TCI indication message may include or correspond to DCI or a MAC CE. If a DCI is used, the TCI indication message may be a dedicated DCI (e.g., implicit beam switch DCI or implicit beam switch activation DCI) or may be a TC indication in a conventional DCI. Although the example of FIG. 5 illustrates a positive indication or activation, a negative activation could be used in other implementations. For example, the base station 105 may indicate to implement or activate the implicit beam switch and to use the implicitly determined beam by the UE 115 by not transmitting a particular message. To illustrate, by not transmitting a MAC CE or DCI during the time window the base station 105 may indicate to activate implicit beam switching.

At 525, the UE 115 switches to the implicitly indicated beam. For example, the implicit beam switching manager 415 of the UE 115 determines the implicit beam and switches from a first beam to a second beam (i.e., the implicit beam) and uses the second beam for one or more wireless communications (e.g., DL, UL, SL, a combination thereof, etc.).

Although the implicit beam switch occurs at or after the end of the time window (e.g., an activation type time window or activation time window) in the example of FIG. 5, in other implementations the implicit beam switch occurs immediately after reception of the activation message or after a delay (e.g., at a time after reception of the activation message).

Alternatively, in other aspects the base station 105 does not transmit an activation message during the time window and the UE 115 determines to not perform an implicit beam switch and does not use the implicitly determined beam after the time window.

Although the example in FIG. 5 is directed to a time window reliability enhancement for implicit beam indication for implicit beam switching operations, the time window (e.g., a TCI activation time window) may be used for implicit beam activation for implicit beam switching operations in addition to or the alternative of implicit beam indication. In such implementations, a time window (e.g., a TCJ indication time window) for implicit beam activation is used to activate implicitly indicated TCI activation information, such as a list of activated TCIs for the UE 115.

Thus, in the example in FIG. 5, the devices utilize a time window to enable reliability enhancements for implicit beam indication for implicit beam switching operations. That is, the UE 115 receives an activation message which indicates to switch to the implicitly determined beam.

Referring to FIG. 6, FIG. 6 is a ladder diagram 600 of a time window reliability enhancement for implicit beam switching operations according to some aspects. In the example of FIG. 6, the ladder diagram illustrates a UE 115 and a network entity, such as base station 105, utilizing a confirmation type time window or confirmation time window.

In other examples and aspects, the implicit beam switching operations may occur between two wireless communication devices, such as two UEs.

In some implementations, the base station 105 optionally transmits a RRC Configuration transmission (not shown). The RRC configuration transmission may configure one or more parameters of the implicit beam switching operations, such as including one or more parameters of the reliability enhancements.

At 610, the UE 115 generates and transmits a CSI report to the network device. For example, the UE 115 generates a CSI report and transmits the CSI report to the base station 105 (such as a gNB). The CSI report may include TCI state information which indicates a TCI state. The TCI state may implicitly indicate or correspond to a particular beam.

The UE 115 and base station 105 determine the beam for implicit switching based on the CSI report. For example, the implicit beam switching manager 415 of the UE 115 determines the beam based on the TCI state information of the CSI report. To illustrate, the UE 115 determines a TCI state based on the TCI state information of the CSI report, and then determines a corresponding beam based on the determined TCI state.

At 615, the base station 105 receives the CSI report and implicitly determines the beam that the UE 115 will switch to a particular beam. For example, the implicit beam switching manager 439 of the base station 105 receives the CSI report and determines the TCI state indicated by the CSI report. The base station 105 may then determine a particular beam based on, and which corresponds to, the TCI state for one or more wireless communications. The beam switch is an implicit one and it occurs independent of a TCT activation message.

At 620, the UE 115 switches to the implicitly indicated beam. For example, the implicit beam switching manager 415 of the UE 115 determines the implicit beam and switches from a first beam to a second beam (i.e., the implicit beam) and uses the second beam for one or more wireless communications (e.g., DL, UL, SL, a combination thereof, etc.).

The UE 115 may determine the implicitly indicated beam as described with reference to FIG. 5.

Although the implicit beam switch occurs at or after the beginning of the time window in the example of FIG. 6, in other implementations the implicit beam switch occurs immediately after transmission of the CSI report or after a delay from the CSI report. The implicit beam switch may occur before a start of the time window.

The UE 115 and base station 105 determine a time window for implicit beam switching. The UE 115 and base station 105 may determine a confirmation type time window from the CSI report and based on a previous configuration transmission or stored/preconfigured settings. For example, a timing of the time window may be determined by offsets from the transmission of the CSI report. As compared to the time window of FIG. 5, which is associated with a delay in the use of the implicitly determined beam, the time window of FIG. 6 is associated with use of the implicitly determined beam. As shown in the example of FIG. 6, the use of the implicitly determined beam may occur after a delay from the CSI report and during at least a portion of the time window. Thus, the UE 115 may use the implicitly determined beam without network input and may determine to continue use of the beam based on network signaling.

At 625, the base station 105 optionally transmits a confirmation message during the time window. For example, the implicit beam switching manager 439 of the base station 105 determines whether or not to confirm the implicit beam switch and whether or not to allow the UE 115 to continue to use the implicitly determined beam by the UE 115. In response to determining to confirm the implicit beam switch and use of the implicitly determined beam by the UE, the base station 105 generates and transmits the confirmation message during the time window as illustrated in FIG. 6. The confirmation message may include or correspond to DCI or a MAC CE. If a DCI is used, the confirmation message may be a dedicated DCI (e.g., implicit beam switch DCI or implicit beam switch confirmation DCI) or may be a TCI indication in a conventional DCI. Although the example of FIG. 6 illustrates a positive indication or confirmation, a negative confirmation could be used in other implementations. For example, the base station 105 may indicate to confirm the implicit beam switch by not transmitting a particular message. To illustrate, by not transmitting a MAC CE or DCI during the time window the base station 105 may indicate to confirmation the implicit beam switch which already took place.

At 630, the UE 115 determines to continue using the implicitly indicated beam. For example, the implicit beam switching manager 415 of the UE 115 determines the implicit beam and switches from a first beam to a second beam (i.e., the implicit beam) and uses the second beam for one or more wireless communications (e.g., DL, UL, SL, a combination thereof, etc.).

Alternatively, in other aspects the base station 105 does not transmit a confirmation message during the time window and the UE 115 determines to cease using/not continue using the implicitly determined beam. In such implementations, the UE 115 may determine to revert back to the original beam or to switch to a default beam or a newly indicated/explicitly indicated beam. The explicitly indicated beam may be indicated by separate or additional signaling, such as conventional beam switching signaling.

Although the example in FIG. 6 is directed to a time window reliability enhancement for implicit beam indication for implicit beam switching operations, the time window may be used for implicit beam activation for implicit beam switching operations in addition to or the alternative of implicit beam indication. In such implementations, a time window (e.g., a confirmation type time window) for implicit beam activation is used to confirm implicitly indicated TCI activation information, such as a list of activated TCIs for the UE 115.

Thus, in the example in FIG. 6, devices utilize a time window (e.g., a confirmation type time window) to enable reliability enhancements for implicit beam indication for implicit beam switching operations. That is, the UE 115 receives a confirmation message which indicates to continue the use of the implicitly determined beam.

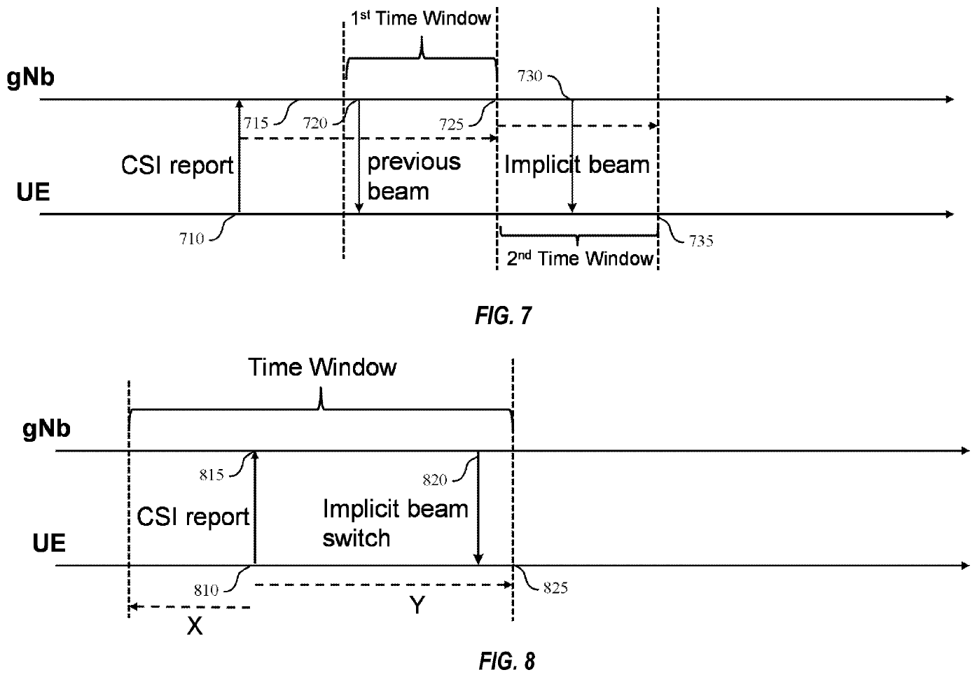

Referring to FIG. 7, FIG. 7 is a ladder diagram 700 of a time window reliability enhancement for implicit beam switching operations according to some aspects. In the example of FIG. 7, the ladder diagram illustrates a UE 115 and a network entity, such as base station 105, utilizing a rejection type time window or rejection time window. In other examples and aspects, the implicit beam switching operations may occur between two wireless communication devices, such as two UEs. Additionally, the ladder diagram 700 further illustrates using multiple windows, such any of activation, confirmation, rejection, cancellation, etc. In the example of FIG. 7, a first time window (e.g., rejection type time window) and a second time window (e.g., a confirmation type time window) are used in a serial fashion (e.g., without overlap). In other aspects, other combinations and timings may be used.

In some implementations, the base station 105 optionally transmits a RRC Configuration transmission (not shown). The RRC configuration transmission may configure one or more parameters of the implicit beam switching operations, such as including one or more parameters of the reliability enhancements.

At 710, the UE 115 generates and transmits a CSI report to the network device. For example, the UE 115 generates a CSI report and transmits the CSI report to the base station 105 (such as a gNB). The CSI report may include TCI state information which indicates a TCI state. The TCI state may implicitly indicate or correspond to a particular beam.

The UE 115 and base station 105 determine the beam for implicit switching based on the CSI report. For example, the implicit beam switching manager 415 of the UE 115 determines the beam based on the TCI state information of the CSI report. To illustrate, the UE 115 determines a TCI state based on the TCI state information of the CSI report, and then determines a corresponding beam based on the determined TCI state.

At 715, the base station 105 receives the CSI report and implicitly determines the beam that the UE 115 will switch to a particular beam. For example, the implicit beam switching manager 439 of the base station 105 receives the CSI report and determines the TCI state indicated by the CSI report. The base station 105 may then determine a particular beam based on, and which corresponds to, the TCI state for one or more wireless communications. The beam switch is an implicit one and it occurs independent of a TCI activation message.

The UE 115 and base station 105 determine a first time window (e.g., rejection type time window) for implicit beam switching. The UE 115 and base station 105 may determine the first time window from the CSI report and based on a previous configuration transmission or stored/preconfigured settings. For example, a timing of the first time window may be determined by offsets from the transmission of the CSI report.

The UE 115 and base station 105 further determine a second time window (e.g., activation or confirmation type time window) for implicit beam switching. In the example of FIG. 7, the UE 115 and base station 105 may determine the second time window from the CSI report and based on a previous configuration transmission or stored/preconfigured settings. For example, a timing of the second time window may be determined by offsets from the transmission of the CSI report. Although the second time window is illustrated as taking place after the first time window, in other implementations, the time windows may be reversed, partially overlap, be separate by a gap, etc.

At 720, the base station 105 optionally transmits a rejection message during the first time window. For example, the implicit beam switching manager 439 of the base station 105 determines whether or not to reject the implicit beam switch and to use the implicitly determined beam by the UE 115. In response to determining to reject the implicit beam switch and use of the implicitly determined beam by the UE, the base station 105 generates and transmits the rejection message during the first time window. The rejection message may include or correspond to DCI or a MAC CE. If a DCI is used, the rejection message may be a dedicated DCI (e.g., implicit beam switch DCI or implicit beam switch rejection DCI) or may be a TCI indication in a conventional DCI. Although the example of FIG. 7 illustrates a positive rejection indication, a negative rejection indication could be used in other implementations. For example, the base station 105 may indicate to reject the implicit beam switch by not transmitting a particular message. To illustrate, by not transmitting a MAC CE or DCI during the first time window the base station 105 may indicate to reject implicit beam switching.

At 725, the UE 115 switches to the implicitly indicated beam. For example, the implicit beam switching manager 415 of the UE 115 determines the implicit beam and switches from a first beam to a second beam (i.e., the implicit beam) and uses the second beam for one or more wireless communications (e.g., DL, UL, SL, a combination thereof, etc.) in response to not receiving a rejection message during the first time window (or not receiving a rejection indication during the first time window). The UE 115 may determine the implicitly indicated beam as described with reference to FIG. 5.

Although the implicit beam switch occurs at or after the beginning of the time window in the example of FIG. 7, in other implementations the implicit beam switch occurs immediately after transmission of the CSI report or after a delay from the CSI report. The implicit beam switch may occur before a start of the second time window.

At 730, the base station 105 optionally transmits a confirmation message during the second time window (e.g., confirmation type time window). For example, the implicit beam switching manager 439 of the base station 105 determines whether or not to confirm the implicit beam switch and whether or not to allow the UE 115 to continue to use the implicitly determined beam by the UE 115. In response to determining to confirm the implicit beam switch and use of the implicitly determined beam by the UE, the base station 105 generates and transmits the confirmation message during the second time window as illustrated in FIG. 7. The confirmation message may include or correspond to DCI or a MAC CE. If a DCI is used, the confirmation message may be a dedicated DCI (e.g., implicit beam switch DCI or implicit beam switch activation DCI) or may be a TCI indication in a conventional DCI. Although the example of FIG. 7 illustrates a positive indication or confirmation, a negative confirmation could be used in other implementations. For example, the base station 105 may indicate to confirm the implicit beam switch by not transmitting a particular message. To illustrate, by not transmitting a MAC CE or DCI during the second time window the base station 105 may indicate to confirmation the implicit beam switch which already took place.

At 735, the UE 115 determines to continue using the implicitly indicated beam. For example, the implicit beam switching manager 415 of the UE 115 determines the implicit beam and switches from a first beam to a second beam (i.e., the implicit beam) and uses the second beam for one or more wireless communications (e.g., DL, UL, SL, a combination thereof, etc.).

Alternatively, in other aspects the base station 105 does not transmit a confirmation message during the second time window and the UE 115 determines to cease using/not continue using the implicitly determined beam. In such implementations, the UE 115 may determine to revert back to the original beam or to switch to a default beam or a newly indicated/explicitly indicated beam. The explicitly indicated beam may be indicated by separate or additional signaling, such as conventional beam switching signaling.

Although the example in FIG. 7 is directed to time window (e.g., using multiple types of time window including a rejection type) reliability enhancements for implicit beam indication for implicit beam switching operations, the time window may be used for implicit beam activation for implicit beam switching operations in addition to or the alternative of implicit beam indication. In such implementations, a time window (e.g., rejection type) for implicit beam activation is used to reject implicitly indicated TCI activation information, such as a list of activated TCIs for the UE 115.

Additionally, although the example in FIG. 7 illustrates the use of multiple time windows for implicit beam indication for implicit beam switching operations, the multiple time windows may be used for implicit beam activation for implicit beam switching operations in addition to or the alternative of implicit beam indication. In such implementations, multiple time windows for implicit beam activation are used to signal implicitly indicated TCJ activation information, such as a list of activated TCIs for the UE 115. In addition, although two time windows are illustrated in the example of FIG. 7, in other examples more than two time windows may be used.

Thus, in the example in FIG. 7, devices utilize multiple windows, such as rejection and confirmation type time windows, to enable reliability enhancements for implicit beam indication for implicit beam switching operations. That is, the UE 115 uses the implicitly determined beam based on not receiving a rejection indication and receiving a confirmation or activation indication. The use of multiple windows may enable a network to manage implicit beam switching even during peak usage or congested networks. That is, using multiple windows may enable the network to indicate positive or negative indications for implicit beam switching with positive signaling or negative signaling (i.e., the absence of sending a transmission).

Referring to FIG. 8, FIG. 8 is a ladder diagram 800 of a time window reliability enhancement for implicit beam switching operations according to some aspects. In the example of FIG. 7, the ladder diagram illustrates a UE 115 and a network entity, such as base station 105, utilizing a cancellation type time window or pre-cancellation time window. In other examples and aspects, the implicit beam switching operations may occur between two wireless communication devices, such as two UEs. Additionally, the ladder diagram 700 further illustrates using multiple windows, such any of activation, confirmation, rejection, cancellation, etc. In the example of FIG. 8, a pre-cancellation type time window is used which corresponds to a window where the network may signal to cancel implicit beam switching operations. For example, upon receiving a cancellation indication the UE 115 may treat the CSI report as a regular CSI report and does not perform any implicit beam switch or further beam switching operations (e.g., ignores other implicit beam switching time windows).

In some implementations, the base station 105 optionally transmits a RRC Configuration transmission (not shown). The RRC configuration transmission may configure one or more parameters of the implicit beam switching operations, such as including one or more parameters of the reliability enhancements.

At 810, the UE 115 generates and transmits a CSI report to the network device. For example, the UE 115 generates a CSI report and transmits the CSI report to the base station 105 (such as a gNB). The CSI report may include TCI state information which indicates a TCI state. The TCI state may implicitly indicate or correspond to a particular beam.

The UE 115 and base station 105 determine the beam for implicit switching based on the CSI report. For example, the implicit beam switching manager 415 of the UE 115 determines the beam based on the TCI state information of the CSI report. To illustrate, the UE 115 determines a TCI state based on the TCI state information of the CSI report, and then determines a corresponding beam based on the determined TCI state.

At 815, the base station 105 receives the CSI report and implicitly determines the beam that the UE 115 will switch to a particular beam. For example, the implicit beam switching manager 439 of the base station 105 receives the CSI report and determines the TCI state indicated by the CSI report. The base station 105 may then determine a particular beam based on, and which corresponds to, the TCI state for one or more wireless communications. The beam switch is an implicit one and it occurs independent of a TCI activation message.

The UE 115 and base station 105 determine time window for implicit beam switching. The UE 115 and base station 105 may determine the time window from the CSI report and based on a previous configuration transmission or stored/preconfigured settings. For example, a timing of the time window may be determined by offsets from a timing of the CSI report. In the example of FIG. 8, the time window starts before the CSI report is even transmitted. This enables the network to deactivate or cancel implicit beam switching before the switch and before at least a portion of the implicit beam switching operations are carried out. The time window may give the network more options and/or time to control the implicit beam switching.

In other implementations, the UE 115 and base station 105 may further determine one or more other windows (e.g., activation, rejection, or confirmation type time windows) for implicit beam switching, as described above.

At 820, the base station 105 optionally transmits a cancellation message during the time window. For example, the implicit beam switching manager 439 of the base station 105 determines whether or not to cancel implicit beam switching operations or the implicit beam switch and the implicitly determined beam by the UE 115. In response to determining to cancel the implicit beam switch and use of the implicitly determined beam by the UE, the base station 105 generates and transmits the cancellation message during the time window. The cancellation message may include or correspond to DCI or a MAC CE. If a DCI is used, the cancellation message may be a dedicated DCI (e.g., implicit beam switch DCI or implicit beam switch rejection DCI) or may be a TCI indication in a conventional DCI. Although the example of FIG. 8 illustrates a positive cancellation indication, a negative cancellation indication could be used in other implementations. For example, the base station 105 may indicate to cancel the implicit beam switch by not transmitting a particular message. To illustrate, by not transmitting a MAC CE or DCI during the time window the base station 105 may indicate to cancel implicit beam switching.

At 825, the UE 115 switches to the implicitly indicated beam. For example, the implicit beam switching manager 415 of the UE 115 determines the implicit beam and switches from a first beam to a second beam (i.e., the implicit beam) and uses the second beam for one or more wireless communications (e.g., DL, UL, SL, a combination thereof, etc.) in response to not receiving a cancellation message during the time window (or not receiving a cancellation indication during the time window). The UE 115 may determine the implicitly indicated beam as described with reference to FIG. 5.

Thus, in the example in FIG. 8, devices utilize multiple time windows, such as cancellation and confirmation type time windows, to enable reliability enhancements for implicit beam indication for implicit beam switching operations. That is, the UE 115 uses the implicitly determined beam based on not receiving a rejection indication and receiving a confirmation or activation indication.

Additionally, or alternatively, one or more operations of FIGS. 3-8 may be added, removed, substituted in other implementations. For example, in some implementations, the example steps of FIGS. 5 and 8 may be used together. To illustrate, a device may use the activation type time window of FIG. 5 and the pre-cancellation type time window of FIG. 8 concurrently or serially. As another example, some of the operations of FIGS. 3 and 4 may be used with the steps of any of FIGS. 5-8.

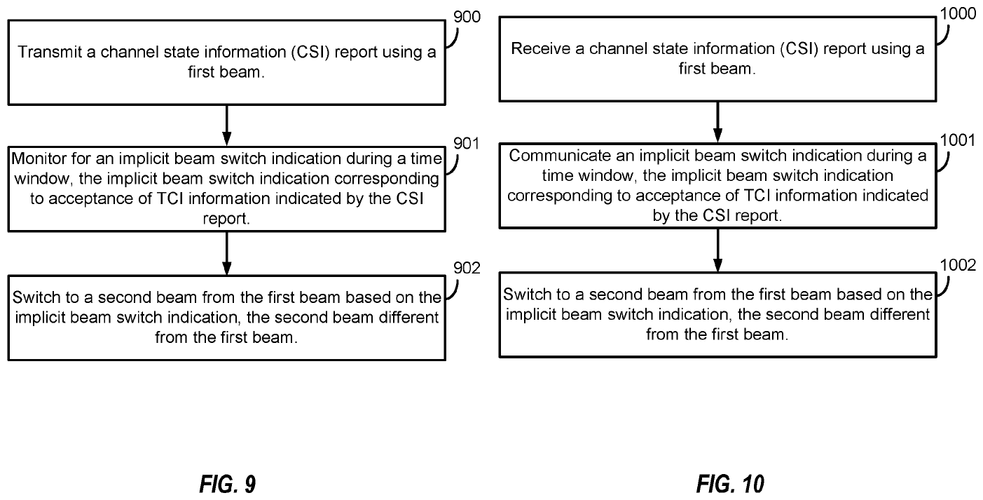

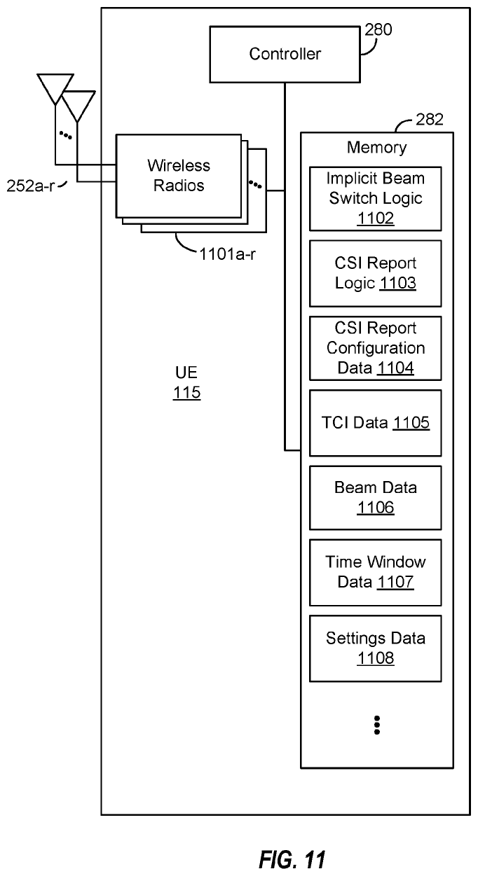

FIG. 9 is a flow diagram illustrating example blocks executed by a wireless communication device (e.g., a UE or base station) configured according to an aspect of the present disclosure. The example blocks will also be described with respect to UE 115 as illustrated in FIG. 11. FIG. 11 is a block diagram illustrating UE 115 configured according to one aspect of the present disclosure. UE 115 includes the structure, hardware, and components as illustrated for UE 115 of FIGS. 2 and/or 4. For example, UE 115 includes controller/processor 280, which operates to execute logic or computer instructions stored in memory 282, as well as controlling the components of UE 115 that provide the features and functionality of UE 115. UE 115, under control of controller/processor 280, transmits and receives signals via wireless radios 110la-r and antennas 252a-r. Wireless radios 1101a-r includes various components and hardware, as illustrated in FIG. 2 for UE 115, including modulator/demodulators 254a-r, MIMO detector 256, receive processor 258, transmit processor 264, and TX MIMO processor 266. As illustrated in the example of FIG. 11, memory 282 stores implicit beam switching logic 1102, CSI report logic 1103, CSI report configuration data logic 1104, TCI data 1105, beam data 1106, time window data 1107, and settings data 1108.

At block 900, a wireless communication device, such as a UE, transmits a channel state information (CSI) report. For example, the UE 115 transmits the CSI report transmission 452 of FIG. 4 to the base station 105, as described with reference to FIGS. 3-8. The CSI report may be generated based on CMRs and may be an implicit beam switch type CSI report. A type of the CSI report may be dependent on whether the CSI report is being used for implicit TCI activation or implicit TCI indication. That is, whether the CSI report implicitly indicates a group of TCI states to active or a particular active/activated TCI state to use. In some aspects, the UE may be indicated to use a first beam (e.g., a TCI) to transmit or receive channels or RSs including any of PUCCH, PUSCH, SRS PDSCH, PDCCH, or CSI-RS. The UE may use the first beam to transmit the CSI report.

At block 901, the UE 115 monitors for an implicit beam switch indication during a time window, the implicit beam switch indication corresponding to acceptance of TCI information indicated by the CSI report. For example, the UE 115 receives a message (e.g., implicit beam switch signaling transmission of FIG. 4) from the base station 105 during the time window or does not receive a message from the base station 105 during the time window to provide the indication for implicit beam switching operations, as described with reference to FIGS. 3-9. The UE 115 then determines the implicit beam switch indication based on whether or not it received a message during the time window and based on implicit beam operation configurations or settings. The communication of the implicit beam switch indication during the time window may be by action or omission.

Optionally, the UE 115 determines the implicit beam switch indication based on the contents of the message, such as bit or field of the message which indicates a positive or negative acknowledgment or another beam to use.

The time window may be a TCI activation time window or a TCI indication time window. That is the time window and indication may correspond to implicit TCI activation operations or implicit TCI indication operations. For either TCI activation or indication, a type of the time window may be any of the time window types described with reference to FIGS. 4-8, such as an activation type time window (e.g., activation time window), as a confirmation type time window (e.g., confirmation time window), as a rejection type time window (e.g., rejection time window), as a cancellation type time window (e.g., pre-cancellation time window), or any combination thereof.

At block 902, the UE 115 switches to a second beam from the first beam based on the implicit beam switch indication, the second beam different from the first beam. For example, the UE 115 switches beams to the implicitly indicated beam in the CSI report or a second CSI report based on the implicit beam indication, as described with reference to FIGS. 4-8. To illustrate, the UE 115 switches from the first beam (such as the beam used to transmit the CSI report) to a second beam. The UE 115 may use the second beam to transmit or receive message, such as to transmit or receive an implicit beam transmission 456 of FIG. 4.

The wireless communication device (e.g., UE or base station) may execute additional blocks (or the wireless communication device may be configured further perform additional operations) in other implementations. For example, the wireless communication device (e.g., the UE 115) may perform one or more operations described above. As another example, the wireless communication device (e.g., the UE 115) may perform one or more aspects as presented below.

In a first aspect, the UE further: transmits a second CSI report; receives a MAC CE indicating a group of configured TCIs to activate; activates the group of configured TCIs; selects a particular active TCI of the configured TCIs; generates the CSI report to indicate the particular active TCI, wherein the second beam is indicated by the particular active TCI, and wherein switching to the second beam is responsive to the implicit beam switch indication.

In a second aspect, alone or in combination with one or more of the above aspects, the UE further: generates the CSI report to indicate a group of configured TCIs to activate; activates the group of configured TCIs based on the implicit beam switch indication; selects a particular active TCJ of the configured TCIs; transmits a second CSI report indicating the particular active TCI; and receives a DCI indicating the particular active TCI, wherein switching to the second beam is further based on the DCI

In a third aspect, alone or in combination with one or more of the above aspects, the UE further: generates the CSI report to indicate a group of configured TCIs to activate; activates the group of configured TCIs based on the implicit beam switch indication; and selects a particular active TCJ of the configured TCIs; transmits a second CSI report indicating the particular active TCI; and monitors for a second implicit beam switch indication during a second time window, the second implicit beam switch indication corresponding to acceptance of TCI activation information indicated by the second CSI report, wherein switching to the second beam is further based on the second implicit beam switch indication responsive to the second implicit beam switch indication.

In a fourth aspect, alone or in combination with one or more of the above aspects, the CSI report comprises an implicit activation CSI report, and wherein the wireless communication device activates the group of TCIs without receiving a TCI activation.

In a fifth aspect, alone or in combination with one or more of the above aspects, the CSI report comprises an implicit indication CSI report, and wherein the wireless communication device switches the beam without receiving a TCI indication.

In a sixth aspect, alone or in combination with one or more of the above aspects, the CSI report comprises an implicit indication or activation CSI report, and wherein the wireless communication device switches the beam without receiving a TCI activation or a TCI indication.

In a seventh aspect, alone or in combination with one or more of the above aspects, the UE further receives a RRC message indicating a TCI list configuration, the TCI list configuration indicating a list of configured TCI states for the wireless communication device to use.

In an eighth aspect, alone or in combination with one or more of the above aspects, the time window is an activation time window, wherein the time window starts from a first time offset from after transmission of the CSI report, and wherein the time window ends from a second time offset from after transmission of the CSI report.

In a ninth aspect, alone or in combination with one or more of the above aspects, the activation time window corresponds to a time period for activating the implicit beam switch, and wherein the beam switch occurs at or after the end of the time window (e.g., at or after the second offset).

In a tenth aspect, alone or in combination with one or more of the above aspects, the UE further receives a RRC message indicating the first offset and the second offset.

In an eleventh aspect, alone or in combination with one or more of the above aspects, the first offset and the second offset are preconfigured (retrieving from memory, upon startup, network connection, etc.).

In a twelfth aspect, alone or in combination with one or more of the above aspects, the UE further: receives a message during the activation time window; and determines to activate the second beam based on the message.

In a thirteenth aspect, alone or in combination with one or more of the above aspects, no message is received during the activation time window, and UE further determines to activate the second beam based on not receiving a message during the activation time window.

In a fourteenth aspect, alone or in combination with one or more of the above aspects, the UE further: performs a second implicit beam switch operation which includes: transmitting a second CSI report indicating a third beam; monitoring a second activation time window based on the second CSI report; receiving an indication of a fourth beam (an explicit beam) during the second activation time window; determining to switch beams to the fourth beam instead of the implicit third beam; and switching to the fourth beam from the second beam.

In a fifteenth aspect, alone or in combination with one or more of the above aspects, the UE further: performs a second implicit beam switch operation which includes: transmitting a second CSI report indicating a third beam; monitoring a second activation time window based on the second CSI report; receives an indication of the second beam or a previous beam during the second activation time window; and determining to maintain the second beam based on the indication.

In a sixteenth aspect, alone or in combination with one or more of the above aspects, the indication is receiving a TCI indication DCI which indicates an implicit TCI as implied by the CSI report.

In a seventeenth aspect, alone or in combination with one or more of the above aspects, the indication is receiving a TCI indication DCI which indicates an implicit TCI as implied by the CSI report or the indication is not receiving DCI indicating a TCI.

In an eighteenth aspect, alone or in combination with one or more of the above aspects, the indication is not receiving a DCI indicating a TCI.

In a nineteenth aspect, alone or in combination with one or more of the above aspects, the indication is receiving a DL MAC-CE confirming the implicit TCI indication.

In a twentieth aspect, alone or in combination with one or more of the above aspects, the time window is a confirmation time window, wherein the confirmation time window starts from a first time offset from after transmission of the CSI report, and wherein the confirmation time window ends from a second time offset from after transmission of the CSI report.

In a twenty-first aspect, alone or in combination with one or more of the above aspects, the confirmation time window corresponds to a window where the implicit beam is used temporarily and the UE monitors for confirmation of continued use of the implicit beam, and wherein the beam switch occurs at or after the start of the confirmation time window (e.g., at or after the first offset).

In a twenty-second aspect, alone or in combination with one or more of the above aspects, the UE further: receives a message during the confirmation time window; and determines to keep using the second beam based on the message.

In a twenty-third aspect, alone or in combination with one or more of the above aspects, no message is received during the confirmation time window, and the UE further determines to keep using the second beam based on not receiving a message during the confirmation time window.

In a twenty-fourth aspect, alone or in combination with one or more of the above aspects, the time window is a rejection time window, wherein the time window starts from a first time offset from transmission of the CSI report, and wherein the time window ends from a second time offset from transmission of the CSI report.

In a twenty-fifth aspect, alone or in combination with one or more of the above aspects, the rejection time window comprises a time window for rejecting the implicit beam switch, and wherein the beam switch occurs at or after the start of the rejection time window (e.g., at or after the second offset).

In a twenty-sixth aspect, alone or in combination with one or more of the above aspects, the UE further: receives a message during the rejection time window; and determines to keep using the second beam based on the message.

In a twenty-seventh aspect, alone or in combination with one or more of the above aspects, no message is received during the rejection time window, and the UE further determines to keep using the second beam based on not receiving a message during the rejection time window.

In a twenty-eighth aspect, alone or in combination with one or more of the above aspects, the UE further monitors a second time window for a second indication, wherein switching to the second beam is based further on the second indication.

In a twenty-ninth aspect, alone or in combination with one or more of the above aspects, the time window is rejection time window and the second time window is a confirmation time window.

In a thirtieth aspect, alone or in combination with one or more of the above aspects, the UE further receives a message during the second time window, wherein no message is received during the time window; and determines to keep using the second beam based on the message during the second time window and not receiving a message during time window.

In a thirty-first aspect, alone or in combination with one or more of the above aspects, the rejection indication comprises a TCI indication in a DCI or a MAC-CE or a dedicated DCI.

In a thirty-second aspect, alone or in combination with one or more of the above aspects, the first time window (e.g., rejection type time window) is shorter than the second time window (e.g., confirmation type time window).

In a thirty-third aspect, alone or in combination with one or more of the above aspects, the first window comprises a rejection time window, and wherein the second window comprises an activation time window.

In a thirty-fourth aspect, alone or in combination with one or more of the above aspects, the first window comprises a pre-cancellation time window, and wherein the second window comprises an activation time window, a confirmation time window, or a rejection time window.

In a thirty-fifth aspect, alone or in combination with one or more of the above aspects, the UE further monitors, a third time window for a third indication, wherein switching to the second beam is based further on the third indication, wherein the third time window comprises an activation type time window, a confirmation type time window, a rejection type time window, or a pre-cancellation type time window.

In a thirty-sixth aspect, alone or in combination with one or more of the above aspects, the time window is a pre-cancellation time window, wherein the pre-cancellation time window starts from a first time offset from before transmission of the CSI report, and wherein the time window ends from a second time offset from before or after transmission of the CSI report.

In a thirty-seventh aspect, alone or in combination with one or more of the above aspects, the pre-cancellation time window comprises a window where the wireless communication device may receive a message which indicates to cease implicit beam switch operations and to not switch beams to the implicit beam (e.g., treat the CSI report as a regular CSI report), and wherein the beam switch occurs at or after the end of the pre-cancellation time window (e.g., at or after the second offset).

In a thirty-eighth aspect, alone or in combination with one or more of the above aspects, the UE further: receives a cancellation indication in a second pre-cancellation time window; and determines not to perform a second implicit beam switch (for the CSI or implicit CSI) based on the cancellation indication.

In a thirty-ninth aspect, alone or in combination with one or more of the above aspects, the cancellation indication comprises a TCI indication in a DCI or a MAC-CE or a dedicated DCI.

In a fortieth aspect, alone or in combination with one or more of the above aspects, the UE further: receives an implicit beam operation activation message (e.g., RRC message); and determines to perform implicit beam switch operations based on CSI reports responsive to the implicit beam operation activation message.

In a forty-first aspect, alone or in combination with one or more of the above aspects, the UE further: receives an implicit beam operation configuration message (e.g., RRC message); and determines configuration settings for implicit beam switch operations based on the implicit beam operation configuration message.

In a forty-second aspect, alone or in combination with one or more of the above aspects, the time window comprises a TCI activation time window or a TCI indication time window.

Accordingly, wireless communication devices may perform enhanced implicit beam switching operations. By performing enhanced implicit beam switching operations throughput and reliability may be increased.

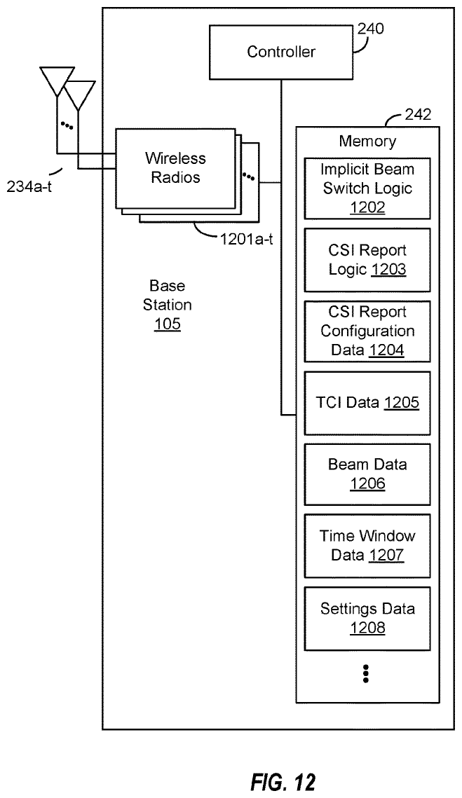

FIG. 10 is a flow diagram illustrating example blocks executed wireless communication device (e.g., a UE or base station) configured according to an aspect of the present disclosure. The example blocks will also be described with respect to base station 105 as illustrated in FIG. 12. FIG. 12 is a block diagram illustrating base station 105 configured according to one aspect of the present disclosure. Base station 105 includes the structure, hardware, and components as illustrated for base station 105 of FIGS. 2 and/or 4. For example, base station 105 includes controller/processor 280, which operates to execute logic or computer instructions stored in memory 282, as well as controlling the components of base station 105 that provide the features and functionality of base station 105. Base station 105, under control of controller/processor 280, transmits and receives signals via wireless radios 1201a-t and antennas 234a-t. Wireless radios 1201a-t includes various components and hardware, as illustrated in FIG. 2 for base station 105, including modulator/demodulators 232a-r, MIMO detector 236, receive processor 238, transmit processor 220, and TX MIMO processor 230. As illustrated in the example of FIG. 12, memory 282 stores implicit beam switching logic 1202, CSI report logic 1203, CSI report configuration data logic 1204, TCI data 1205, beam data 1206, time window data 1207, and settings data 1208.

At block 1000, a wireless communication device, such as a base station, receives a channel state information (CSI) report using a first beam. For example, the base station 105 receives the CSI report transmission 452 of FIG. 4 from the UE 115, as described with reference to FIGS. 3-9.

At block 1001, the base station 105 communicates an implicit beam switch indication during a time window, the implicit beam switch indication corresponding to acceptance of TCI information indicated by the CSI report. For example, the base station 105 transmits a message (e.g., implicit beam switch signaling transmission of FIG. 4) to the UE 115 during the time window or refrains from transmitting a message to the UE 115 during the time window to provide the indication for implicit beam switching operations, as described with reference to FIGS. 3-9. The communication of the implicit beam switch indication during the time window may be by action or omission. The time window may correspond to a time window as described with reference to FIGS. 3-9.

At block 1002, the base station 105 switches to the second beam from the first beam based on the implicit beam switch indication, where the second beam is different from the first beam. For example, the base station 105 switches beams to the implicitly indicated beam in the CSI report or in a second CSI report based on the implicit beam indication, as described with reference to FIGS. 4-8. To illustrate, the base station 105 switches from the first beam (such as the beam used to receive the CSI report) to a second beam. The base station 105 may use the second beam to transmit or receive message, such as to transmit or receive an implicit beam transmission 456 of FIG. 4.

The wireless communication device (e.g., such as UE or base station) may execute additional blocks (or the wireless communication device may be configured further perform additional operations) in other implementations. For example, the wireless communication device may perform one or more operations described above. As another example, the wireless communication device may perform one or more aspects as described with reference to FIG. 9.

In a first aspect, the UE further: determines the second beam based on a TCI state in the CSI report; and determines whether to accept an implicit beam switch to the second beam, wherein the implicit beam switch indication is transmitted responsive to determining to accept the implicit beam switch.

In a second aspect, alone or in combination with one or more of the above aspects, the UE further: transmits a transmission during the time window; or refrains from transmitting a transmission during the time window.

In a third aspect, alone or in combination with one or more of the above aspects, the time window comprises a TCJ activation time window or a TCI indication time window.

Accordingly, wireless communication devices may perform enhanced implicit beam switching operations. By performing enhanced implicit beam switching operations throughput and reliability may be increased.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-12 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both.

To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium.

Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication comprising:
transmitting, by a wireless communication device, a channel state information (CSI) report using a first beam;
monitoring, by the wireless communication device, for an implicit beam switch indication during a time window, the implicit beam switch indication corresponding to acceptance of Transmission Configuration Indicator (TCI) information indicated by the CSI report; and
switching, by the wireless communication device, to a second beam from the first beam based on the implicit beam switch indication, the second beam different from the first beam.

2. The method of claim 1, further comprising, prior to switching to the second beam:
transmitting, by the wireless communication device, a second CSI report;
receiving, by the wireless communication device, a MAC CE indicating a group of configured TCIs to activate;
activating, by the wireless communication device, the group of configured TCIs;
selecting, by the wireless communication device, a particular active TCI of the configured TCIs; and
generating, by the wireless communication device, the CSI report to indicate the particular active TCI, wherein the second beam is indicated by the particular active TCI, and wherein switching to the second beam is responsive to the implicit beam switch indication.

3. The method of claim 1, further comprising, prior to switching to the second beam:
generating, by the wireless communication device, the CSI report to indicate a group of configured TCIs to activate;
activating, by the wireless communication device, the group of configured TCIs based on the implicit beam switch indication;
selecting, by the wireless communication device, a particular active TCI of the configured TCIs;
transmitting, by the wireless communication device, a second CSI report indicating the particular active TCI; and
receiving, by the wireless communication device, a DCI indicating the particular active TCI, wherein switching to the second beam is further based on the DCI.

4. The method of claim 1, further comprising, prior to switching to the second beam:
generating, by the wireless communication device, the CSI report to indicate a group of configured TCIs to activate;
activating, by the wireless communication device, the group of configured TCIs based on the implicit beam switch indication; and
selecting by the wireless communication device, a particular active TCI of the configured TCIs;
transmitting, by the wireless communication device, a second CSI report indicating the particular active TCI; and
monitoring, by the wireless communication device, for a second implicit beam switch indication during a second time window, the second implicit beam switch indication corresponding to acceptance of TCI activation information indicated by the second CSI report, wherein switching to the second beam is further based on the second implicit beam switch indication responsive to the second implicit beam switch indication.

5. The method of claim 1, wherein the CSI report is an implicit activation CSI report, and wherein the wireless communication device activates a group of TCIs without receiving a TCJ activation.

6. The method of claim 1, wherein the CSI report is an implicit indication CSI report, and wherein the wireless communication device switches to the second beam without receiving a TCJ indication.

7. The method of claim 1, wherein the CSI report is an implicit indication or activation CSI report, and wherein the wireless communication device switches to the second beam without receiving a TCI activation or a TCJ indication.

8. The method of claim 1, further comprising:
receiving, by the wireless communication device, a RRC message indicating a TCI list configuration, the TCI list configuration indicating a list of configured TCI states for the wireless communication device to use.

9. The method of claim 1, wherein the time window is an activation time window, wherein the time window starts from a first time offset from after transmission of the CSI report, and wherein the time window ends from a second time offset from after transmission of the CSI report transmission.

10. The method of claim 9, wherein the activation time window corresponds to a time period for activating an implicit beam switch, and wherein switching to the second beam occurs at or after the end of the time window.

11. The method of claim 9, further comprising:
receiving, by the wireless communication device, a RRC message indicating the first offset and the second offset.

12. The method of claim 9, wherein the first offset and the second offset are preconfigured.

13. The method of claim 9, further comprising:
receiving, by the wireless communication device, a message during the activation time window; and
determining, by the wireless communication device, to activate the second beam based on the message.

14. The method of claim 9, wherein no message is received during the activation time window, and further comprising:
determining, by the wireless communication device, to activate the second beam based on not receiving a message during the activation time window.

15. The method of claim 9, further comprising:
performing a second implicit beam switch operation including:
transmitting, by the wireless communication device, a second CSI report indicating a third beam;
monitoring, by the wireless communication device, a second activation time window based on the second CSI report;
receiving, by the wireless communication device, an indication of a fourth beam during the second activation time window;
determining, by the wireless communication device, to switch beams to the fourth beam instead of the third beam which is implicitly indicates by the second CSI report; and
switching, by the wireless communication device, to the fourth beam from the second beam.

16. The method of claim 9, further comprising:
performing a second implicit beam switch operation including:
transmitting, by the wireless communication device, a second CSI report indicating a third beam;
monitoring, by the wireless communication device, a second activation time window based on the second CSI report;
receiving, by the wireless communication device, an indication of the second beam or a previous beam during the second activation time window; and
determining, by the wireless communication device, to maintain the second beam based on the indication.

17. The method of claim 1, wherein the implicit beam switch indication is receiving a TCI indication DCI which indicates an implicit TCI as implied by the CSI report.

18. The method of claim 1, wherein the implicit beam switch indication is receiving a TCI indication DCI which indicates an implicit TCI as implied by the CSI report or the implicit beam switch indication is not receiving DCI indicating a TCI.

19. The method of claim 1, wherein the implicit beam switch indication is not receiving a DCI indicating a TCI.

20. The method of claim 1, wherein the implicit beam switch indication is receiving a MAC-CE confirming an implicit TCJ indication in the CSI report.

21. The method of claim 1, wherein the time window is a confirmation time window, wherein the confirmation time window starts from a first time offset from after transmission of the CSI report, and wherein the confirmation time window ends from a second time offset from after transmission of the CSI report.

22. The method of claim 21, wherein the confirmation time window corresponds to a window where an implicitly indicated beam is used temporarily and the wireless communication device monitors for confirmation of continued use of the implicitly indicated beam, and wherein switching to the second beam occurs at or after the start of the confirmation time window.

23. The method of claim 22, further comprising:
receiving, by the wireless communication device, a message during the confirmation time window; and
determining, by the wireless communication device, to keep using the second beam based on the message.

24. The method of claim 22, wherein no message is received during the confirmation time window, and further comprising:
determining, by the wireless communication device, to keep using the second beam based on not receiving a message during the confirmation time window.

25. The method of claim 1, wherein the time window is a rejection time window, wherein the time window starts from a first time offset from transmission of the CSI report, and wherein the time window ends from a second time offset from transmission of the CSI report.

26. The method of claim 25, wherein the rejection time window comprises a time window for rejecting an implicit beam switch, and wherein switching to the second beam occurs at or after the start of the rejection time window.

27. The method of claim 26, further comprising:
receiving, by the wireless communication device, a message during the rejection time window; and
determining, by the wireless communication device, to keep using the second beam based on the message.

28. The method of claim 26, wherein no message is received during the rejection time window, and further comprising:
determining, by the wireless communication device, to keep using the second beam based on not receiving a message during the rejection time window.

29. The method of claim 1, further comprising:
monitoring, by the wireless communication device, a second time window for a second indication, wherein switching to the second beam is based further on the second indication.

30. The method of claim 29, wherein the time window is rejection time window and the second time window is a confirmation time window.

31. The method of claim 29, further comprising:
receiving, by the wireless communication device, a message during the second time window, wherein no message is received during the time window; and
determining, by the wireless communication device, to keep using the second beam based on the message during the second time window and not receiving a message during time window.

32. The method of claim 29, wherein the second indication is a rejection indication, and wherein the rejection indication comprises a TCI indication in a DCI or a MAC-CE or a dedicated DCI.

33. The method of claim 29, wherein the time window is shorter than the second time window.

34. The method of claim 29, wherein the time window comprises a rejection time window, and wherein the second time window comprises an activation time window.

35. The method of claim 29, wherein the time window comprises a pre-cancellation time window, and wherein the second time window comprises an activation time window, a confirmation time window, or a rejection time window.

36. The method of claim 1, further comprising:
monitoring, by the wireless communication device, a third time window for a third indication, wherein switching to the second beam is based further on the third indication, wherein the third time window comprises an activation time window, a confirmation time window, a rejection time window, or a pre-cancellation time window.

37. The method of claim 1, wherein the time window is a pre-cancellation time window, wherein the pre-cancellation time window starts from a first time offset from before transmission of the CSI report, and wherein the time window ends from a second time offset from before or after transmission of the CSI report.

38. The method of claim 37, wherein the pre-cancellation time window comprises a window where the wireless communication device may receive a message which indicates to cease implicit beam switch operations and to not switch beams to an implicitly indicated beam, and wherein the beam switch occurs at or after the end of the pre-cancellation time window.

39. The method of claim 37, further comprising:
receiving, by the wireless communication device, a cancellation indication in a second pre-cancellation time window; and
determining, by the wireless communication device, not to perform a second implicit beam switch based on the cancellation indication.

40. The method of claim 39, wherein the cancellation indication comprises a TCI indication in a DCI or a MAC-CE or a dedicated DCI.

41. The method of claim 1, further comprising:
receiving, by the wireless communication device, an implicit beam operation activation message; and
determining, by the wireless communication device, to perform implicit beam switch operations based on CSI reports responsive to the implicit beam operation activation message.

42. The method of claim 1, further comprising:
receiving, by the wireless communication device, an implicit beam operation configuration message; and
determining, by the wireless communication device, configuration settings for implicit beam switch operations based on the implicit beam operation configuration message.

43. A method of wireless communication comprising:
transmitting, by a wireless communication device, a channel state information (CSI) report using a first beam, the CSI report indicating a set of Transmission Configuration Indicator (TCI) states to activate from a list of configured TCJ states;
monitoring, by the wireless communication device, for an indication to activated the set of TC states; and
activating, by the wireless communication device, the set of TCJ states based on the indication.

44. A method of wireless communication comprising:
transmitting, by a wireless communication device, a channel state information (CSI) report using a first beam, the CSI report indicating a particular Transmission Configuration Indicator (TCI) state of a set of active TCI states to use, wherein the particular TCJ state indicates a second beam;
monitoring, by the wireless communication device, for an indication to use the second beam which is implicitly indicated by the CSI report during a time window, the second beam different from the first beam; and
switching, by the wireless communication device, to the second beam from the first beam based on the indication.

45. A method of wireless communication comprising:
receiving, by a wireless communication device, a channel state information (CSI) report using a first beam;
communicating, by the wireless communication device, an implicit beam switch indication during a time window, the implicit beam switch indication corresponding to acceptance of Transmission Configuration Indicator (TCI) information indicated by the CSI report; and
switching, by the wireless communication device, to a second beam from the first beam based on the implicit beam switch indication, the second beam different from the first beam.

46. The method of claim 45, further comprising:
determining, by the wireless communication device, the second beam based on a TCJ state in the CSI report; and
determining, by the wireless communication device, whether to accept an implicit beam switch to the second beam, wherein the implicit beam switch indication is transmitted responsive to determining to accept the implicit beam switch.

47. The method of claim 45, wherein communicating the implicit beam switch indication includes:
transmitting, by the wireless communication device, a transmission during the time window; or
refraining, by the wireless communication device, from transmitting a transmission during the time window.

48. The method of claim 45, wherein the time window comprises:
a TCJ activation time window; or
a TCJ indication time window.

49. The method of claim 45, wherein the method further comprises a method as in any of claims 2-42.

50. An apparatus configured for wireless communication, comprising:
at least one processor; and
a memory coupled to the at least one processor,
wherein the at least one processor is configured to:
receive a channel state information (CSI) report using a first beam;
monitor an implicit beam switch indication during a time window, the implicit beam switch indication corresponding to acceptance of Transmission Configuration Indicator (TCI) information indicated by the CSI report; and
switch to a second beam from the first beam based on the implicit beam switch indication, the second beam different from the first beam.

51. The apparatus of claim 50, wherein the apparatus is configured to perform a method as in any of claims 1-42.

52. An apparatus configured for wireless communication, comprising:
means for receiving a channel state information (CSI) report using a first beam;
means for monitoring for an implicit beam switch indication during a time window, the implicit beam switch indication corresponding to acceptance of Transmission Configuration Indicator (TCI) information indicated by the CSI report; and
means for switching to a second beam from the first beam based on the implicit beam switch indication, the second beam different from the first beam.

53. The apparatus of claim 52, wherein the apparatus is configured to perform a method as in any of claims 1-42.

54. A non-transitory, computer-readable medium storing instructions that, when executed by a processor, cause the processor to perform operations comprising:
receiving, by a wireless communication device, a channel state information (CSI) report using a first beam;
monitoring, by the wireless communication device, for an implicit beam switch indication during a time window, the implicit beam switch indication corresponding to acceptance of Transmission Configuration Indicator (TCI) information indicated by the CSI report; and
switching, by the wireless communication device, to a second beam from the first beam based on the implicit beam switch indication, the second beam different from the first beam.

55. The non-transitory, computer-readable medium of claim 54, wherein the processor is configured to perform a method as in any of claims 1-42.

56. An apparatus configured for wireless communication, comprising:
at least one processor; and
a memory coupled to the at least one processor,
wherein the at least one processor is configured to:
receive a channel state information (CSI) report using a first beam;
communicate an implicit beam switch indication during a time window, the implicit beam switch indication corresponding to acceptance of Transmission Configuration Indicator (TCI) information indicated by the CSI report; and
switch to a second beam from the first beam based on the implicit beam switch indication, the second beam different from the first beam.

57. The apparatus of claim 56, wherein the apparatus is configured to perform a method as in any of claims 1-42.

58. An apparatus configured for wireless communication, comprising:
means for receiving a channel state information (CSI) report using a first beam;
means for communicating an implicit beam switch indication during a time window, the implicit beam switch indication corresponding to acceptance of Transmission Configuration Indicator (TCI) information indicated by the CSI report; and
means for switching to a second beam from the first beam based on the implicit beam switch indication, the second beam different from the first beam.

59. The apparatus of claim 58, wherein the apparatus is configured to perform a method as in any of claims 1-42.

60. A non-transitory, computer-readable medium storing instructions that, when executed by a processor, cause the processor to perform operations comprising:
receiving, by a wireless communication device, a channel state information (CSI) report using a first beam;
communicating, by the wireless communication device, an implicit beam switch indication during a time window, the implicit beam switch indication corresponding to acceptance of Transmission Configuration Indicator (TCI) information indicated by the CSI report; and
switching, by the wireless communication device, to a second beam from the first beam based on the implicit beam switch indication, the second beam different from the first beam.

61. The non-transitory, computer-readable medium of claim 60, wherein the processor is configured to perform a method as in any of claims 1-42.
